(19) United States
(12) Patent Application Publication
(10) Pub. No.: US 2015/0261799 A1
(43) Pub. Date: Sep. 17, 2015

(54) SYSTEMS, APPARATUS, AND METHODS FOR TRACKING CHANGES IN DATA STRUCTURES USING NESTED SIGNATURES

(71) Applicant: Siemens Aktiengesellschaft, Munchen (DE)

(72) Inventor: Vincent G. Winstead, Minnetonka, MN (US)

(21) Appl. No.: 14/600,148

(22) Filed: Jan. 20, 2015

Related U.S. Application Data
(60) Provisional application No. 61/952,940, filed on Mar. 14, 2014.

(51) Int. Cl. G06F 17/30

(52) U.S. Cl. CPC G06F 17/30309

(57) ABSTRACT

Embodiments of the present invention provide systems, apparatus, and methods for tracking changes in data structures. Embodiments include a system data structure including a master signature list object and a plurality of component data structures sufficient to define a system. The component data structures each include a signature list object and a plurality of value storage objects sufficient to define a component of the system. The value storage objects are operative to execute on a processor to store changed values. The signature list objects are operative to execute on a processor to store signatures associating a changed value stored within a corresponding component data structure and other current values also stored within the corresponding component data structure. Numerous additional aspects are disclosed.

### RELATED APPLICATIONS

The present application claims priority to U.S. Provisional Application No. 61/952,940 titled “NESTED SIGNATURES FOR EFFICIENT TRACKING OF EDITS” filed Mar. 14, 2014, which is incorporated herein by reference for all purposes.

### FIELD

The present invention relates to data structures, and more specifically to systems, apparatus, and methods for tracking changes in data structures using nested signatures.

### BACKGROUND

Large data structures such as those used to store display data for complex models (e.g., of large systems) that include tabular grids, text, format information, menus, graphics, etc., can be accessed and modified using a dynamic editor in a runtime environment. For example, changes to a display can be made to any number of components in the display component model. Displays can be extremely large in size (for example, having thirty or more tabular grids and numerous other custom components).

One important feature of dynamic editors is change tracking which allows the user to revert the data structure to a prior state. For example, a user may realize than an error was made at some earlier time. Instead of forcing the user to remember and manually undo every change since the error or to abandon all work since a much earlier point in time (e.g., with a known good status), editors typically provide a function that allows the user to see changes and to select a restore point, e.g., before the error was introduced. Some conventional change tracking methods save a version of the entire data structure each time a change is made or periodically based on time or other event. When a user wants to revert the data structure to a prior state, the editor performs a comparison between the current database and the saved versions to identify the changes for the user. Once the user selects how far back into the changes to undo, the editor restores the data structure by simply reverting to the corresponding saved version.

As more complex systems are modeled and data structures grow, it quickly becomes inefficient to use such conventional change tracking methods that store the entire display configuration structure each time a change is made or periodically. Beyond the obviously large storage requirements, finding the differences between two large data structures (e.g., display versions) using conventional methods requires a comparison between the entireties of both data structures. Comparisons between large configurations can present complexities that result in performance drawbacks and ultimately unreliable behaviors.

An alternative conventional change tracking method that requires less storage, stores only incremental changes to a data structure. However, this method suffers from a number of drawbacks including the creation of a very long list of changes that must be preserved in order to re-create the data structure by serially reversing every change made since the desired restore point. Thus, this method can also suffer from performance issues as well as not being robust and reliable. Thus, what is needed are improved systems, apparatus, and methods for tracking changes in data structures.

### SUMMARY

In some embodiments, the present invention provides a system for tracking changes in data structures. The system includes a system data structure including a master signature list object and a plurality of component data structures sufficient to define a system. The component data structures each include a signature list object and a plurality of value storage objects sufficient to define a component of the system. The value storage objects are operative to execute on a processor to store changed values. The signature list objects are operative to execute on a processor to store signatures associating a changed value stored within a corresponding component data structure and other current values also stored within the corresponding component data structure. Numerous additional aspects are disclosed.

In some other embodiments, the present invention provides an apparatus for tracking changes in a data structure. The apparatus includes a processor; a memory coupled to the processor and operative to store instructions executable on the processor to provide a component data structure including a signature list object and a plurality of value storage objects sufficient to define a component of a system data structure; store a changed value in one of the value storage objects; and store a new signature associating the changed value and current values of other value storage objects in the signature list object.

In yet other embodiments, the present invention provides a method for tracking changes in a data structure. The method includes providing a component data structure including a signature list object and a plurality of value storage objects sufficient to define a component of a system data structure; storing a changed value in one of the value storage objects; and storing a new signature associating the changed value and current values of other value storage objects in the signature list object.

Still other features, aspects, and advantages of the present invention will become more fully apparent from the following detailed description, the appended claims, and the accompanying drawings by illustrating a number of exemplary embodiments and implementations, including the best mode contemplated for carrying out the present invention. Embodiments of the present invention may also be capable of other and different applications, and its several details may be modified in various respects, all without departing from the spirit and scope of the present invention. Accordingly, the drawings and descriptions are to be regarded as illustrative in nature, and not as restrictive. The drawings are not necessarily drawn to scale. The description is intended to cover all modifications, equivalents, and alternatives falling within the spirit and scope of the claims.

### BRIEF DESCRIPTION OF THE DRAWINGS

FIG. 1 is a block diagram depicting an example object-oriented programming (OOP) class representative of an edit tracker component data structure according to embodiments of the present invention.

FIG. 2 is a block diagram depicting a first example of relationships between elements of the example class of FIG. 1 according to embodiments of the present invention.

FIG. 3 is a block diagram depicting a second example of relationships between elements of the example class of FIG. 1 according to embodiments of the present invention.

FIG. 4 is a block diagram depicting an example OOP class representative of an edit tracker system data structure according to embodiments of the present invention.

FIG. 5 is a flowchart illustrating an example method of tracking changes in a data structure according to embodiments of the present invention.

### DESCRIPTION

Embodiments of the present invention provide systems, apparatus, and methods for tracking changes in a data structure using signatures. In some embodiments, a computer software application executable on a processor is provided that allows editing and change tracking of a data structure in a runtime environment. The data structure can include a number of different components including tabular grids, text, format information, controls, menus, graphics, etc. Through the use of signatures, a randomly accessible list of versions of the data structure can be tracked efficiently both in terms of the volume of data stored and performance.

At the most basic level, “signatures,” as the term is used herein, refers to collections or sets of identifiers, where each identifier specifies a version of a component of a data structure. For example, if a data structure has ten components, each signature would include a set of ten identifiers, one identifier for each component. Thus, according to embodiments of the present invention, a data structure is organized into a number of components and each time data within a component is changed, a new version of the component is saved and a new signature is created that references the new version of the changed component along with all the other components of the data structure as they existed at the time of the change. Thus, to track data changes, instead of storing an entire copy of the data structure each time a change is made, only the component that actually changes is saved along with a new signature. Therefore, each entry in a list of signatures can be thought of as set of associated component versions that coexisted at one time. This list of signatures provides a historical sequence of component changes and allows the data structure to be returned to a desired restore point before any selected change without having to serially step through each and every change.

In some embodiments of the invention, the components can be broken down into sub-components (or “values”) and tracking of changes can be further granulized to the sub-component level. In other words, a “sub-signature list” of sub-components can be maintained that stores associations of sub-component versions and instead of storing an entire component each time part of a component changes, only the changed sub-component is stored along with an updated sub-signature list. Similarly, in some embodiments, changes can be tracked above the individual component level. In other words, groups of components can be associated using a “master signature list” that specifies which versions of components go together as a set representing a historical state of the data structure. For example, the highest signature list value of each component can be used to represent a current value/status of a component in the master signature list entries. Thus, each master signature list entry includes a set of signature list values, one for each component. In this manner, embodiments of the present invention can include different levels of nesting. Each level includes its own signature list and each entry associates the elements tracked at that level based on either “atomic” values at the lowest level or next lower level signature list values at any level above the lowest level.

In some embodiments, any number of levels of nesting can be used by defining higher level categories for the elements of the given level. For example, a fourth level above the “groups of components” level described above could be a “group of files” level where each group of components is stored in a different file and a “super master signature list” tracks which file versions of the files go together. A fifth level above the “groups of files” level could be a “directories” level where each group of files is stored in a different directory in a computer with multiple directories and a “super super master signature list” is used to associate versions of directories. In some embodiments for example, a partitions level, a hard disk level, and/or a computer level can be defined. Many other nesting levels can be defined beyond the eight examples listed above.

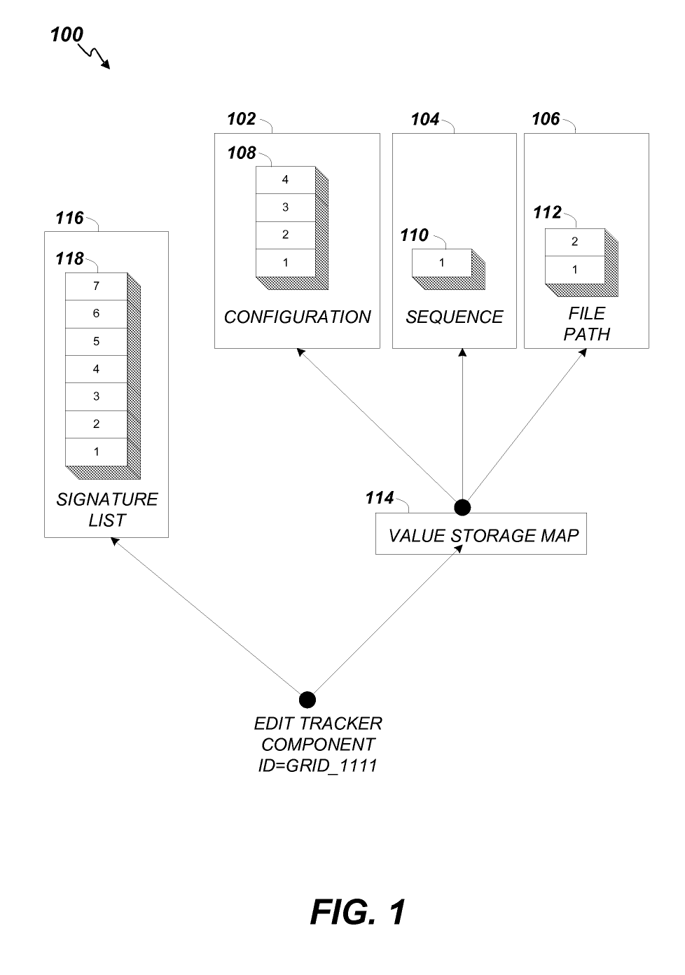

Turning now to FIG. 1, details of an example implementation of a component data structure 100 for a “value” level or atomic level object-oriented programming (OOP) class is described. The component data structure 100 includes an arbitrary number of value storage array objects 102, 104, 106 that are sufficient to define the values of the component being tracked. In some embodiments, additional values (i.e., value storage array objects) can be added, and existing values can be removed, from component data structures as a user edits the data structure.

In the specific example provided, three value storage array objects 102, 104, 106 are depicted but depending on the type of component that is being tracked, more or fewer values can be included. In this case, the component data structure 100 represents a grid (e.g., a spreadsheet) and the grid is defined by a configuration, a sequence, and a file path. Thus, the three example value storage array objects 102, 104, 106 include a configuration array 108, a sequence array 110, and a file path array 112. Each numbered block in the arrays 108, 110, 112 corresponds to an entry (i.e., a stored value) that represents a change to the corresponding tracked value. A value storage map 114 provides a common container for the value storage array objects 102, 104, 106 which are tracked for the corresponding component. The index of which version of the value storage array objects 102, 104, 106 is defined in a signature list object 116. Thus, the component data structure 100 also includes a signature list object 116 that includes a signature array 118.

The signature array 118 includes an entry for every change that has been made to the values of the component being tracked. In the example, seven entries are shown. Thus, the “GRID_{—}1111” has been changed six times since the original values. Each entry in the signature array 118 includes a number of values corresponding to the number of values used to define the component.

As described above, three values are included in the depicted example component. Thus, each of the seven signature array 118 entries would include three version numbers, each indicating a version stored in one of the corresponding three value storage array objects 102, 104, 106. In other words, the set of three version numbers in each entry of the signature array 118 come from the version numbers used to index the values in the configuration array 108, the sequence array 110, and the file path array 112. As can be seen in the example, the configuration array 108 holds four values which indicates the configuration has been changed three times from the original value. Further, the sequence has not been changed since the sequence array 110 only includes one value (i.e., the original value) and the file path has been changed once since the file path array 112 includes two values (i.e., the original value and one changed value).

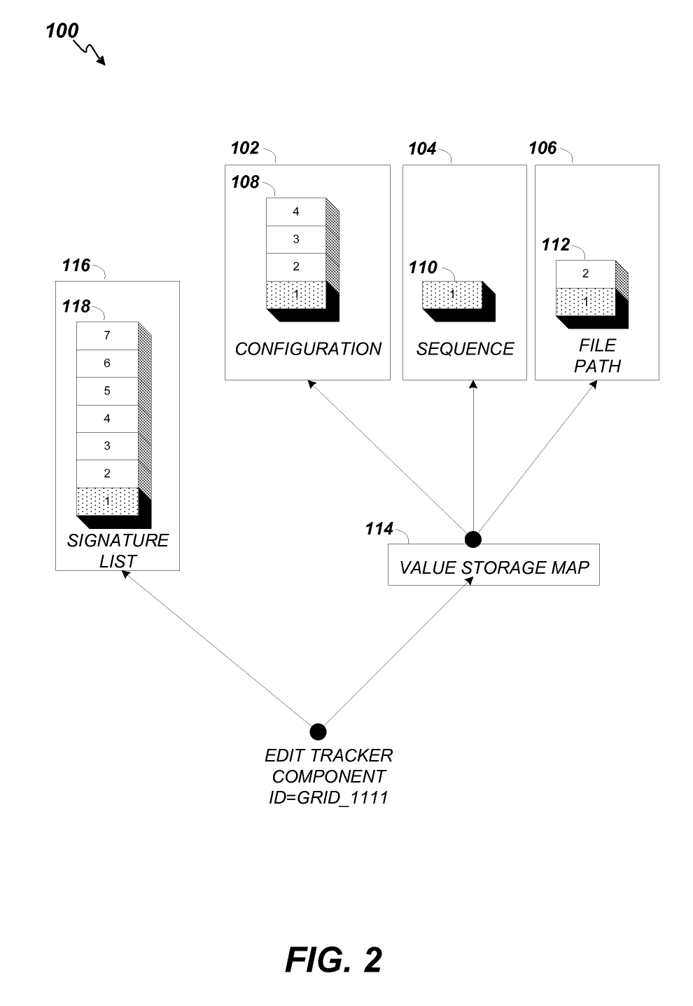

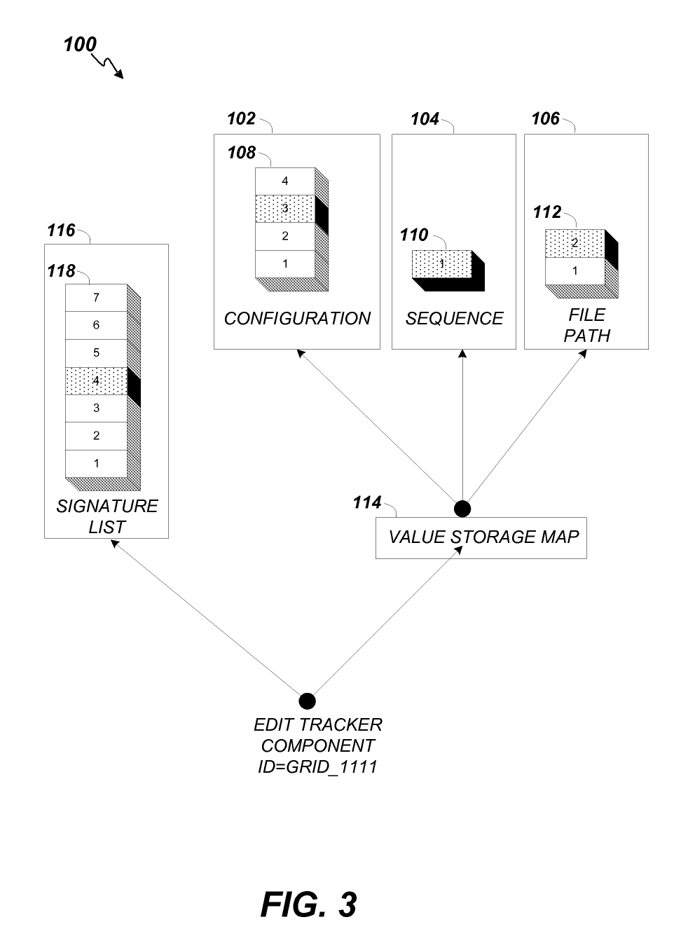

The values stored in the signature array 118 are explained in more detail with respect to the examples depicted in FIGS. 2 and 3. Both FIGS. 2 and 3 depict the same component data structure 100 of FIG. 1 but using stippling, the correspondence between elements of the arrays is indicated. In FIG. 2, the first entry in the signature array 118 is highlighted with stippling and the first entry of the configuration array 108, the sequence array 110, and the file path array 112 are also similarly highlighted. This indicates that the first entry of the configuration array 108 is {1,1,1} meaning that the first entry associates the original values in each of three value storage array objects 102, 104, 106. Note that in some embodiments, the first entry in the signature array 118 can be omitted since it can be assumed the first value always points to the original values in the value storage array objects 102, 104, 106.

Turning to FIG. 3, the highlighting of the fourth entry in the signature array 118 indicates that the state of the component being tracked after the third change in the value storage array objects 102, 104, 106 was {3,1,2}. In other words, the values stored in the third entry in the configuration array 108, the first entry in the sequence array 110, and the second entry in the file path array are associated and together represent the fourth state of the component data structure 100.

As a further illustrative example, example values for the second and third entries in the signature array 118 could be {1,1,2} and {2,1,2} respectively. In other words, the first change to GRID_1111 could have been to the file path value, then to the configuration value, and then to the configuration value again to bring GRID_{—}1111 to the fourth state.

Note that, even though there is only one additional value stored in the value storage array objects 102, 104, 106, there are three additional entries in the signature array 118. This indicates that two of the entries in the signature array 118 store a set of version numbers that specify a reverted state of the tracked component. For example, if at some point after the file path changed from the first value to the second value, the user realized that the third value of the configuration array 108 was incorrect and wanted to revert to {2,1,2}, in some embodiments, there would be an entry created in the signature array 118 (e.g., the sixth entry) but no need to store a new value in any of the value storage array objects 102, 104, 106. In other embodiments, reversion tracking can be handled differently.

In some embodiments, two or more new values can be stored in any of the value storage array objects 102, 104, 106 at the same time, using the same signature. Such an embodiment can be implemented for example if there is a logical dependency between the configuration and the file path. The file path changes because the user did some specific change on the configuration. The user has no knowledge of the sequence or the file path in most cases, these are just internal values used by the application. In other cases, the user could change the file path only, and then change something on the configuration, and in this case there would be two signature entries.

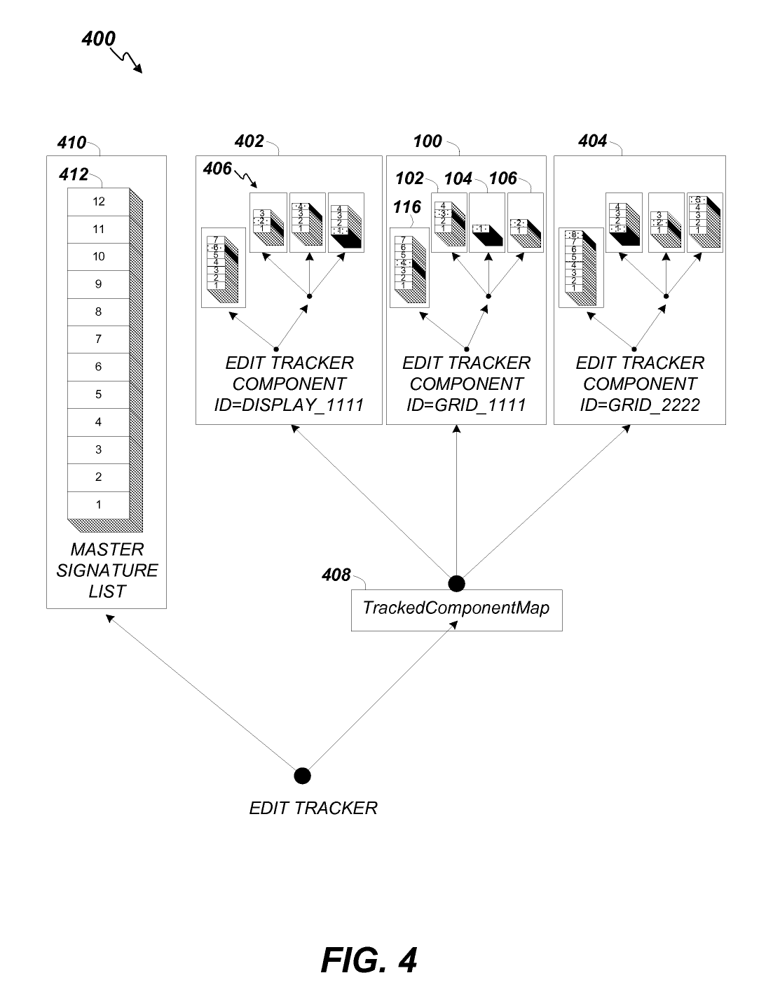

Turning now to FIG. 4, an example OOP class representative of an edit tracker system data structure 400 is shown. The system data structure 400 includes an arbitrary number of component data structures 100, 402, 404 sufficient to define the components of the system being tracked. In other words, collectively, the component data structures 100, 402, 404 represent a complete system data structure 400. In some embodiments, additional components (i.e., component data structures) can be added, and existing values can be removed, from system data structures as a user edits the data structure.

In the specific example provided, three component data structures 100, 402, 404 are depicted but depending on the type of system that is being tracked, more or fewer components can be included. In this case, the system data structure 400 represents an economic model that includes a display and two grids (e.g., spreadsheets). The display is defined by three types of values and the grids each include a configuration, a sequence, and a file path as in the example of FIG. 1. Thus, two of the three example component data structures 100, 402, 404 include a configuration array 108, a sequence array 110, and a file path array 112, as in FIG. 1. The example display component data structure 402 includes three value arrays 406. A tracked component map 408 provides a common container for the component data structures 100, 402, 404 which are tracked for the system data structure 400. The index of which version of the component data structures 100, 402, 404 is defined in a master signature list object 410.

Analogous to the signature list object 116 of the component data structure 100, the system data structure 400 includes a master signature list object 410 that includes a master signature array 412. The master signature array 412 includes an entry for every change that has been made to the components of the system being tracked. In the example, twelve entries are shown. Thus, 11 changes to the components (e.g., taking each entry in the signature array 116 as one change) have been stored since the original values were created. Each entry in the master signature array 412 includes a number of values corresponding to the number of components used to define the system. For example, the most recent signature array 118 values for each of the component data structures 100, 402, 404 can be used to represent the current state of the system. Thus, in the example depicted, the twelfth entry in the master signature array 412 would be {7,7,8} because the signature array 118 for the GRID_{—}1111 has 7 entries, the signature array for the DISPLAY₁₁₁₁ has 7 entries, and signature array for the GRID_{—}2222 has 8 entries.

As discussed above, even though only two levels of nesting are illustrated in the examples described in detail above, multiple levels of nesting can be implemented in embodiments of the invention. Thus, for example, all the component data structures 100, 402, 404 in FIG. 4 could be replaced by system data structures. Further, in some embodiments, a level can be mixed where, for example, any of the component data structures 100, 402, 404 in FIG. 4 could be replaced by a system data structures while some component data structures remain. Thus, in some embodiments, any practicable combination of values, components, and/or systems can coexist on a given level.

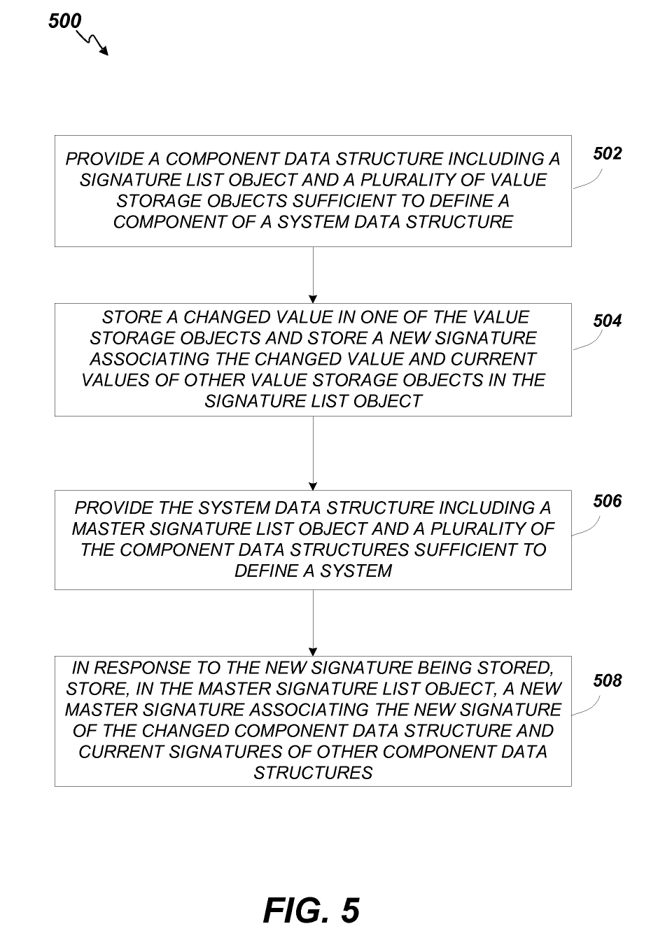

FIG. 5 depicts a flowchart of an example method 500 of tracking changes in a data structure. A component data structure is provided including a signature list object and a plurality of value storage objects sufficient to define a component of a system data structure (502). In response to a change being made to a value in the component data structure, the changed value is stored in the appropriate value storage object and a new signature associating the changed value and the current values in the other value storage objects is stored in the signature list object (504). The system data structure is provided including a master signature list object and a plurality of the component data structures sufficient to define a system (506). In response to the new signature being stored, a new master signature associating the new signature of the changed component data structure and the current signatures of the other component data structures is stored in the master signature list object (508).

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

Each process (whether called a method, class behavior, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component, structure, or article is described herein, more than one device, component, structure or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component, structure, or article is described herein (whether or not they cooperate), a single device, component, structure, or article may alternatively be used in place of the more than one device, component, structure, or article that is described. For example, a plurality of computer-based devices may be substituted with a single computer-based device. Accordingly, the various functionality that is described as being possessed by more than one device, component, structure, or article may alternatively be possessed by a single device, component, structure, or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases and/or data structures are described, it will be understood by one of ordinary skill in the art that (i) alternative database structures to those described may be readily employed, and (ii) other memory structures besides databases may be readily employed. Any illustrations or descriptions of any sample databases/data structure presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

The foregoing description discloses only example embodiments of the invention. Modifications of the above-disclosed apparatus, systems and methods which fall within the scope of the invention will be readily apparent to those of ordinary skill in the art.

Accordingly, while the present invention has been disclosed in connection with exemplary embodiments thereof, it should be understood that other embodiments may fall within the spirit and scope of the invention, as defined by the following claims.

The invention claimed is:

1. A system for tracking changes in data structures, the system comprising:
a system data structure including a master signature list object and a plurality of component data structures sufficient to define a system,
wherein each of the plurality of component data structures include a signature list object and a plurality of value storage objects sufficient to define a component of the system,
wherein the value storage objects are operative to execute on a processor to store changed values,
wherein the signature list objects are operative to execute on a processor to store signatures associating a changed value stored within a corresponding component data structure and other current values also stored within the corresponding component data structure.

2. The system of claim 1 wherein the master signature list object is operative to execute on a processor to store a master signature associating a stored signature of a component data structure having a changed value with current signatures of other component data structures.

3. The system of claim 1 wherein the system is an economic modeling system including at least displays and grids.

4. The system of claim 1 wherein the component data structures define grids and wherein the grids include at least one of configuration data, sequence data, and file path data.

5. The system of claim 1 wherein the system data structure is embodied as an object operative to execute on a processor to facilitate an editor application to provide an undo function back to a user selectable restore point.

6. The system of claim 1 wherein the signature list object is further operative to execute on a processor to store a plurality of signatures in a signature array representing a historical list of changes made to a component data structure.

7. The system of claim 1 wherein the master signature list object is further operative to execute on a processor to store a plurality of master signatures in master signature array representing a historical list of changes made to a system data structure.

8. An apparatus for tracking changes in a data structure, the apparatus comprising:
a processor;
a memory coupled to the processor and operative to store instructions executable on the processor to:
provide a component data structure including a signature list object and a plurality of value storage objects sufficient to define a component of a system data structure;
store a changed value in one of the value storage objects; and
store a new signature associating the changed value and current values of other value storage objects in the signature list object.

9. The apparatus of claim 8 wherein the instructions further include instructions executable on the processor to:
provide the system data structure including a master signature list object and a plurality of the component data structures sufficient to define a system.

10. The apparatus of claim 9 wherein the instructions further include instructions executable on the processor to:
store in the master signature list object a new master signature associating the new signature of the changed component data structure and current signatures of other component data structures.

11. The apparatus of claim 8 wherein the instructions to store a new master signature are executed in response to execution of the instruction to store the new signature.

12. The apparatus of claim 8 wherein the instructions to store a new signature are executed in response to execution of the instruction to store the changed value in one of the value storage objects.

13. The apparatus of claim 8 wherein the instructions further include a data structure editing application.

14. The apparatus of claim 8 wherein the instructions to provide a component data structure further include providing a component data structure representing a grid including at least one of configuration data, sequence data, and file path data.

15. A method for tracking changes in a data structure, the method comprising:
providing a component data structure including a signature list object and a plurality of value storage objects sufficient to define a component of a system data structure;
storing a changed value in one of the value storage objects; and
storing a new signature associating the changed value and current values of other value storage objects in the signature list object.

16. The method of claim 15 further including providing the system data structure including a master signature list object and a plurality of the component data structures sufficient to define a system.

17. The method of claim 15 further including storing in the master signature list object a new master signature associating the new signature of the changed component data structure and current signatures of other component data structures.

18. The method of claim 17 wherein storing the new master signature occurs in response to storing the new signature.

19. The method of claim 15 wherein storing the new signature occurs in response to storing the changed value in one of the value storage objects.

20. The method of claim 15 wherein providing a component data structure further includes providing a component data structure representing a grid including at least one of configuration data, sequence data, and file path data.
